(19) United States
(12) Patent Application Publication
(10) Pub. No.: US 2017/0222710 A1
(43) Pub. Date: Aug. 3, 2017

(54) TRIGGER FRAME FOR CHANGING MODES OF OPERATION

(71) Applicant: QUALCOMM Incorporated, San Diego, CA (US)

(72) Inventors: Alecsander Petru EITAN, Haifa (IL); Amichai SANDEROVICH, Atlit (IL); Gal BASSON, Haifa (IL)

(21) Appl. No.: 15/415,200

(22) Filed: Jan. 25, 2017

Related U.S. Application Data
(60) Provisional application No. 62/288,280, filed on Jan. 28, 2016.

(51) Int. Cl. H04B 7/08; H04B 7/0413; H04B 7/0452; H04B 7/06

(52) U.S. Cl. CPC H04B 7/0871; H04B 7/0689; H04B 7/0413; H04B 7/0452; H04W 92/08

(57) ABSTRACT

Certain aspects of the present disclosure relate to switching mode of operation between an apparatus and a wireless node. An apparatus for wireless communication may generate a first frame comprising one or more fields indicating at least one of a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or one or more parameters related to the change and output the first frame for transmission. Correspondingly, an apparatus for wireless communication may obtain a first frame comprising one or more fields indicating a request to change a mode for communication between the apparatus and a wireless node or parameters related to the change and take one or more actions to communicate in accordance with the change in the mode or the parameters.

### CROSS-REFERENCE TO RELATED APPLICATIONS

This application claims benefit of priority from commonly-owned U.S. Provisional Application Ser. No. 62/288,280, filed on Jan. 28, 2016, entitled “TRIGGER FRAME FOR SU-MIMO,” which is expressly incorporated herein by reference in its entirety.

### FIELD OF THE DISCLOSURE

Certain aspects of the present disclosure generally relate to wireless communication and, more particularly, to generating a frame (which may be referred to as a trigger frame) comprising one or more fields indicating at least one of a request to change a mode for communication between an apparatus and a wireless node or one or more parameters related to the change and outputting the frame for transmission.

### DESCRIPTION OF RELATED ART

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications in a wireless network.

Aspects of the present disclosure generally relate to generating a frame including at least one of a request to change a mode for communication between an apparatus and a wireless node, wherein the change in the mode includes switching to one of single-input single-output (SISO), single-user multi-input multi-output (SU-MIMO), or multi-user MIMO (MU-MIMO) operation, or one or more parameters related to the change and transmitting the frame. Aspects further relate to obtaining the frame including at least one of the request to change the mode for communication or one or more parameters related to the change and taking action based on the obtained frame. According to aspects, the request to change the mode may indicate a request to change the SU mode for communication (between SISO and SU-MIMO)

Certain aspects of the present disclosure provide an apparatus for wireless communications. The apparatus generally includes a processing system configured to obtain a first frame comprising one or more fields indicating at least one of a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or one or more parameters related to the change and a first interface configured to output the first frame for transmission.

Certain aspects of the present disclosure provide an apparatus for wireless communications. The apparatus generally includes a first interface configured to obtain a first frame comprising one or more fields indicating a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or parameters related to the change and a processing system configured to take one or more actions to communicate in accordance with the change in the mode or the parameters related to the change.

Certain aspects of the present disclosure provide a method for wireless communications by an apparatus. The method generally includes generating a first frame comprising one or more fields indicating at least one of a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or one or more parameters related to the change and outputting the first frame for transmission.

Certain aspects of the present disclosure provide a method for wireless communications by an apparatus. The method generally includes obtaining a first frame comprising one or more fields indicating a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or parameters related to the change and taking one or more actions to communicate in accordance with the change in the mode or the parameters related to the change.

Certain aspects of the present disclosure provide an apparatus for wireless communications. The apparatus generally includes means for generating a first frame comprising one or more fields indicating at least one of a request to change a mode for communication between the apparatus and a wireless node, wherein the change in the mode includes switching to one of single-input single-output (SISO), single-user multi-input multi-output (SU-MIMO), or multi-user MIMO (MU-MIMO), operation or one or more parameters related to the change and means for outputting the first frame for transmission.

Certain aspects of the present disclosure provide an apparatus for wireless communications. The apparatus generally includes means for obtaining a first frame comprising one or more fields indicating a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or parameters related to the change and means for taking one or more actions to communicate in accordance with the change in the mode or the parameters related to the change.

Certain aspects of the present disclosure provide a computer readable medium having instructions stored thereon for causing an apparatus for wireless communications to generate a first frame comprising one or more fields indicating at least one of a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or one or more parameters related to the change and output the first frame for transmission.

Certain aspects of the present disclosure provide a computer readable medium having instructions stored thereon for causing an apparatus for wireless communications to obtain a first frame comprising one or more fields indicating a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or parameters related to the change and to take one or more actions to communicate in accordance with the change in the mode or the parameters related to the change.

Certain aspects of the present disclosure provide an access point (AP) for wireless communications. The AP generally includes at least one antenna, a processing system configured to generate a first frame comprising one or more fields indicating at least one of a request to change a mode for communication between the AP and a wireless node, wherein the change in the mode includes switching to one of single-input single-output (SISO), single-user multi-input multi-output (SU-MIMO), or multi-user MIMO (MU-MIMO) operation, or one or more parameters related to the change and a transmitter configured to transmit the first frame via the at least one antenna.

Certain aspects of the present disclosure provide a station for wireless communications. The station includes at least one antenna, a receiver configured to obtain, via the at least one antenna, a first frame comprising one or more fields indicating a request to change a mode for communication between the station and a wireless node, wherein the change in the mode includes switching to one of single-input single-output (SISO), single-user multi-input multi-output (SU-MIMO), or multi-user MIMO (MU-MIMO) operation, or parameters related to the change and a processing system configured to take one or more actions to communicate in accordance with the change in the mode or the parameters related to the change.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communications network, in accordance with certain aspects of the present disclosure.

FIG. 2 is a block diagram of an example access point (AP) and user terminals, in accordance with certain aspects of the present disclosure.

FIG. 3 is a block diagram of an example wireless device, in accordance with certain aspects of the present disclosure.

FIG. 4 is a flow diagram of example operations for wireless communication, in accordance with certain aspects of the present disclosure.

FIG. 4A illustrates example means capable of performing the operations shown in FIG. 4.

FIG. 5 is a flow diagram of example operations for wireless communication, in accordance with certain aspects of the present disclosure.

FIG. 5A illustrates example means capable of performing the operations shown in FIG. 5.

FIG. 6 illustrates an example frame which may be used to trigger a change in SU operations, in accordance with certain aspects of the present disclosure.

FIG. 7 illustrates an example frame which may be used to trigger a change in mode including a change to one of SISO, SU-MIMO, or MU-MIMO operation, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure generally relate to generating a first frame comprising one or more fields indicating at least one of a request to change a mode for communication between an apparatus and a wireless node or one or more parameters related to the change. The apparatus may transmit the generated frame to the wireless node.

Similarly, a wireless node may be configured to obtain a first frame comprising one or more fields indicating a request to change a mode for communication between the wireless node and an apparatus or parameters related to the change and to take one or more actions to communicate in accordance with the change in the mode or the parameters related to the change.

As described herein, the change in mode may refer to switching communication to one of single-input single-output (SISO), single-user multi-input multi-output (SU-MIMO), or multi-user MIMO (MU-MIMO). Accordingly, the frame may indicate a request to change the mode for SU communication between the apparatus and the wireless node or to switch from a SU mode to MU-MIMO.

As described herein, SU communication may refer to communication involving only one station (e.g., apparatus, node, device) for transmission and only one station (e.g., apparatus, node, device) for reception. In SU communication, two stations communicate with a bidirectional link. At a specific time, a single station may be transmitting and the other station may be receiving. Optionally, the two links may be set differently (e.g., one link may be SISO and another may be SU-MIMO).

As will be described in more detail herein, a first field may indicate the request for change in a mode (e.g., a change in the mode for SU communication or a change to MU-MIMO) and a second field may indicate the parameters related to the change. The change in SU mode may relate to switching between one of SISO or SU-MIMO operations by the station. The change in mode (e.g., between SISO, SU-MIMO, and MU-MIMO), may be applied to uplink, downlink, or both uplink and downlink transmissions. The apparatus and wireless node may take one or more actions to communicate in accordance with the change in mode. Communication between the apparatus and the wireless node may include communication between any two stations, communication between two APs, or communication between an AP and a station.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA. Additionally or alternatively, the techniques described herein may be used in a single carrier communication system.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT may be a wireless node. Such wireless node may provide, for example, connectivity for or to a network (e.g., a wide area network such as the Internet or a cellular network) via a wired or wireless communication link.

### An Example Wireless Communication System

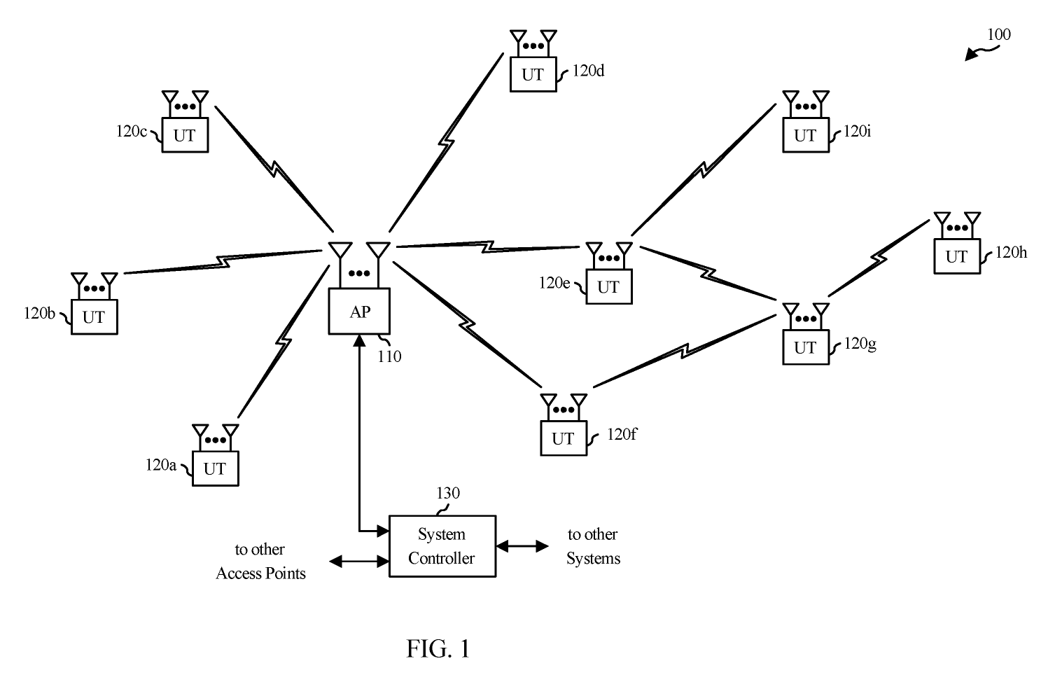

FIG. 1 illustrates a multiple-access multiple-input multiple-output (MIMO) system 100 with APs and UTs/STAs. The MIMO system 100 may be a multi-user MIMO system (MU-MIMO).

Although not illustrated in FIG. 1, the AP and STAs in FIG. 1 may communicate in a single user (SU) communication environment, for example, via, SISO operations or SU-MIMO operations. SU communication may refer to communication involving only one station for each of transmission and reception. In SU communication, the two stations communicate with a bidirectional link. For example, any two wireless nodes may communicate according to SU communications, including, for example, an AP and a STA, two APs (e.g., communication between a first AP and a second AP), two STAs (e.g., communication between a first STA and a second STA). In SU communication, at a specific time, a single node or station may be transmitting and the other node or station may be receiving. Optionally, the two links may be set differently (e.g., one link may be SISO and another may be SU-MIMO).

In a SISO system, the two stations communicating (e.g., AP 110 and STAs 120, two STAs 120, and/or two APs 110) may each employ only a single antenna for transmission and reception. SU-MIMO enables multiple streams of data to be simultaneously transmitted or received between two stations using multiple antennas.

Accordingly, in an environment supporting SU communication, a node (e.g., AP or STA) may be configured to generate a first frame comprising one or more fields indicating at least one of a request to change a mode for communication between the node and a second node (e.g., a second AP or STA) or one or more parameters related to the change and output the first frame for transmission. The change in mode includes switching to or between one of SISO, SU-MIMO, or MU-MIMO.

Correspondingly, a wireless node (e.g., AP or STA) may be configured to obtain a first frame comprising one or more fields indicating a request to change a mode for communication between the node and an second node (e.g., an AP or STA) or parameters related to the change and to take one or more actions to communicate in accordance with the change in the mode or the parameters related to the change. As described above, the change in mode includes switching to or between one of SISO, SU-MIMO, or MU-MIMO.

Thus, as described herein, the frame may be used to trigger a change in the mode for SU communication (between SISO and SU-MIMO) or a change to MU-MIMO.

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

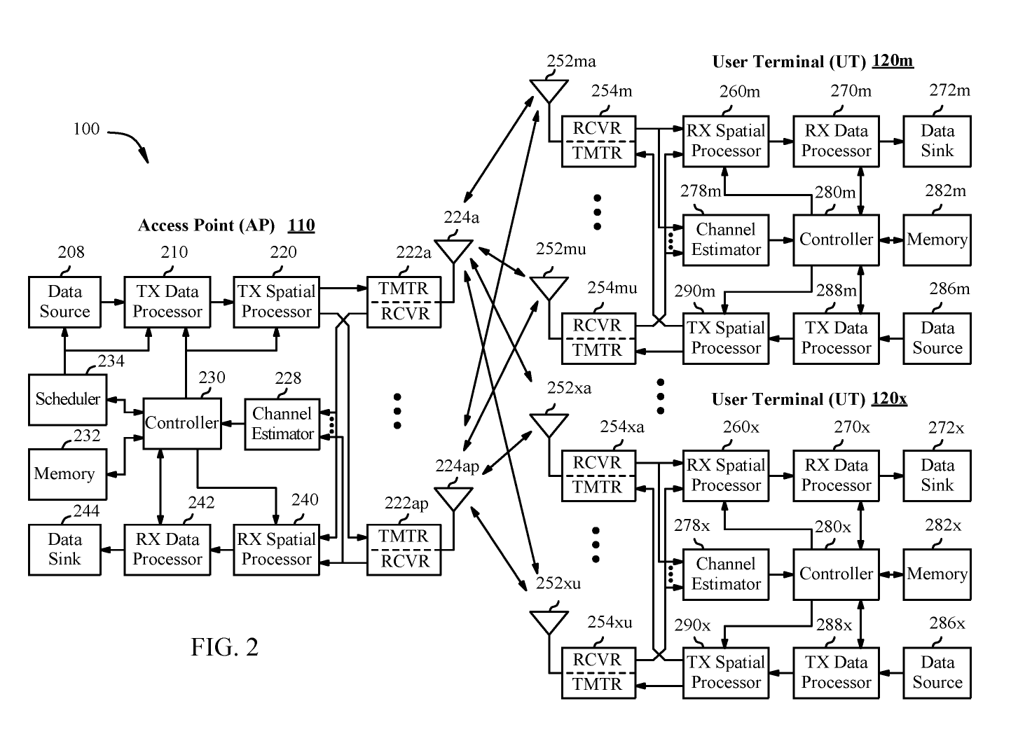

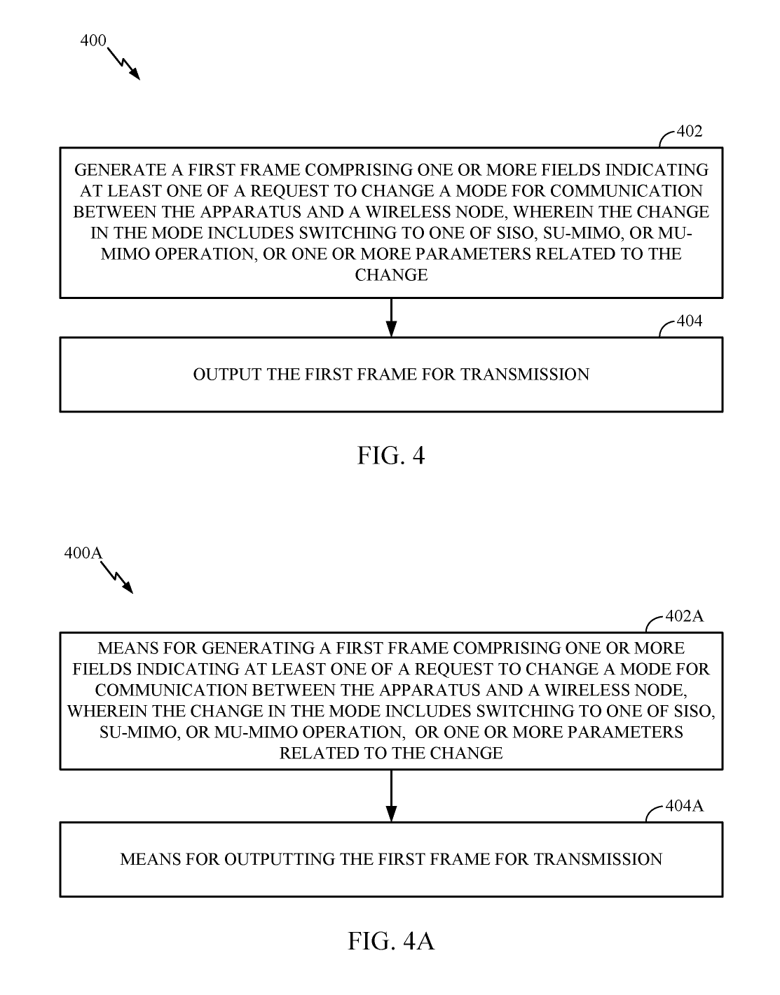

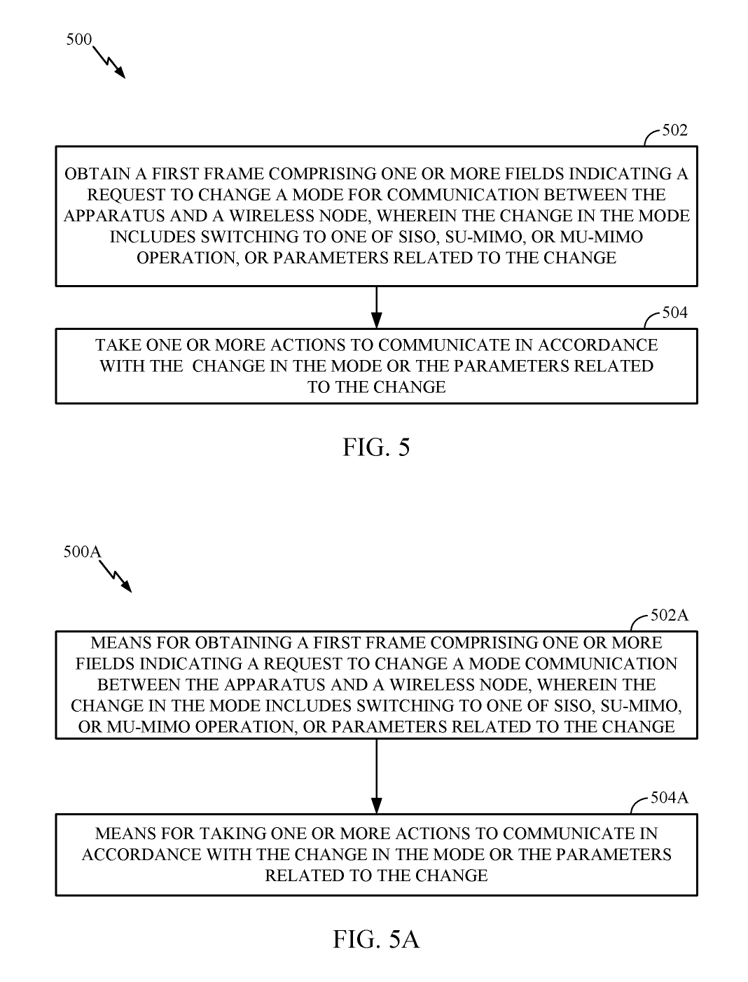

FIG. 2 illustrates example components of the AP 110 and UT/STA 120 illustrated in FIG. 1, which may be used to implement aspects of the present disclosure. One or more components of the AP 110 and STA 120 may be used to practice aspects of the present disclosure. For example, antenna 224, Tx/Rx 222, processors 210, 220, 240, 242, and/or controller 230 of the access point 110 may be used to perform the operations described herein and illustrated with reference to FIGS. 4 and 4A. Similarly, antenna 252, Tx/Rx 254, processors 260, 270, 288, and 290, and/or controller 280 of the STA 120 may be used to perform the operations described herein and illustrated with reference to FIGS. 5 and 5A. According to aspects, antenna 224, Tx/Rx 222, processors 210, 220, 240, 242, and/or controller 230 of the access point 110 may be used to perform the operations described herein and illustrated with reference to FIGS. 5 and 5A and antenna 252, Tx/Rx 254, processors 260, 270, 288, and 290, and/or controller 280 of the STA 120 may be used to perform the operations described herein and illustrated with reference to FIGS. 4 and 4A. As described herein, communication may occur between two APs, two STAs, and/or and AP and a STA.

FIG. 2 illustrates a block diagram of access point 110 two user terminals 120m and 120x in a MIMO system 100. As described above with reference to FIG. 1, the AP and STA may also communicate in a SU system, via, for example SISO or SU-MIMO operations. Accordingly, an AP and STA, a first and second AP, and/or a first and second STA may communicate in a SU system.

The access point 110 is equipped with Nₜ antennas 224a through 224ap. User terminal 120m (STA) is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

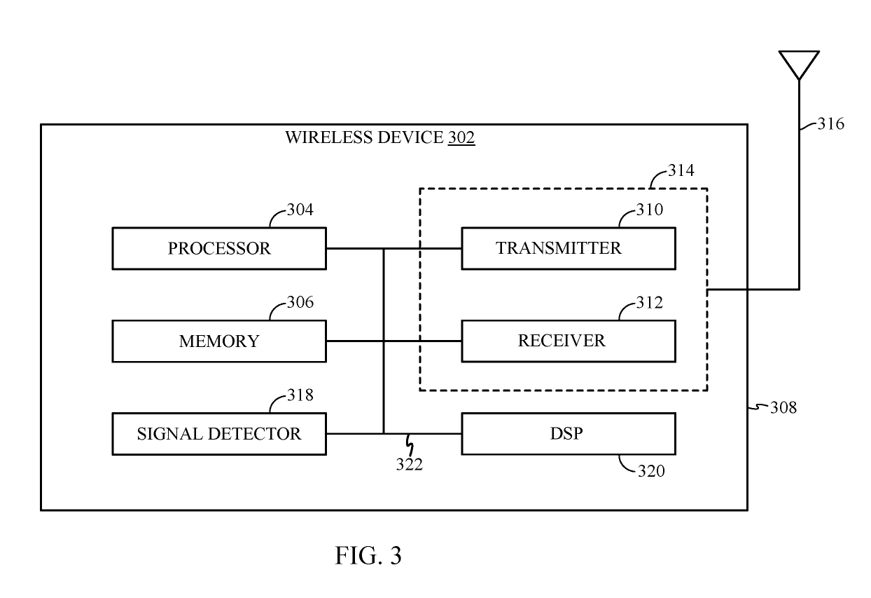

FIG. 3 illustrates various components that may be utilized in a wireless device 302 that may be employed within the MIMO system 100. The wireless device 302 is an example of a device that may be configured to implement the various methods described herein. For example, the wireless device may implement operations 400 and 500 illustrated in FIGS. 4-5, respectively. The wireless device 302 may be an access point (e.g., an apparatus) 110 or STA (e.g., a wireless node) 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. An antenna 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Trigger Frame for Changing a Mode for Communication

Developing communication standards, including 802.11ay, extend throughput of existing standards. Through the use of several technologies such as SU-MIMO and MU-MIMO the throughput may reach up to 100 Gbps per user or aggregated. Wireless nodes operating in accordance with these communication standards may operate at high frequencies (millimeter wave, (mmWave)) above 45 GHz, for example, at 60 GHz. Operations above 45 GHz allow the use of additional technologies, such as analog beamforming.

In conventional MIMO operations, each transmission and reception antenna element may have its own transmitter or receiver path. The paths are processed by digital precoding at the transmit side and digital combining at a receive side.

Operation in mmWave may utilize large antenna arrays on both the transmitter and receiver side in an effort to achieve reasonable link budget. However, using large antenna arrays for transmission and reception may be costly and resource consuming. Accordingly, wireless nodes may not have full transmit and receive paths for each antenna element.

Antenna clusters, referred to as antenna modules, may be used by wireless nodes, where each antenna cluster has a full transmit and receive path. Further, each antenna cluster may have several antenna elements combined by configurable RF elements. These clusters, which may be on different physical modules, may be configured to form a beam by using technologies of phase array and analog beamforming.

For wireless communication according to some developing standards, a device (e.g., station, wireless node) may need to know what transmission it may expect to receive so that it may tune its receiver analog beamformer prior to receiving a MIMO transmission.

Certain, existing standards, may require a receiver to be able to switch receiving modes. For devices operating below 6 GHz, omnidirectional antennas may start receiving a signal and perform beamforming (digital processing) while receiving the signal. For example, the device may receive a preamble and header and may subsequently retune the receiver based on the mode of operation. However, devices operating above 6 GHz may tune a receiver prior to receiving a transmission. In this manner, the device should know the type of transmission it is expected to receive.

Several options exist for allowing devices to know what type of transmission (SU or MU-MIMO) it may receive. In SU communication, two stations communicate with a bidirectional link. At a specific time, a single station may be transmitting and the other station may be receiving. Optionally, the two links may be set differently (e.g., one link may be SISO and another may be SU-MIMO). According to one advantageously straightforward aspect, during association, devices may exchange messages regarding their capabilities. These devices may agree on a highest operation mode. For example, if the highest operation mode supported by both devices is SU-MIMO of 2×2 dimension, they may simply use this for all communications.

The drawbacks of this simplistic approach include that SU-MIMO increases overhead and affects efficiency for low throughput, the link budget of SU-MIMO may limit coverage, and power efficiency may be low for low throughput. Therefore, while SU-MIMO may be desirable for high throughput communication, it may not be desirable to use SU-MIMO all the time.

According to another aspect, devices may, as described above, exchange messages regarding their capabilities. In addition, the devices may renegotiate based on history and other parameters. This may advantageously allow changing modes based on current operating conditions. However, negotiations may be slow, thereby adversely effecting efficiency. Additionally, the negotiation process may be complex thereby increasing overhead.

Accordingly, aspects of the present disclosure provide methods and techniques to trigger a change in mode of SU communication or to change to MU-MIMO communication.

FIG. 4 illustrates example operations 400, in accordance with certain aspects of the present disclosure. The operations 400 may be performed, for example, by an apparatus (e.g., AP 110, STA 120, or any wireless node). The operations 400 may begin, at 402, by generating a first frame comprising one or more fields indicating at least one of a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or one or more parameters related to the change. At 404, the apparatus may output the first frame for transmission.

As described herein, the first frame may be referred to as a trigger frame, a first field may indicate the request to change the mode for communications, and a second field may indicate the parameters related to the change. According to one example, the first field may indicate the request to change the mode of SU communication. For uplink communication, the apparatus may process an obtained (e.g., received) second frame according to the parameters related to the change. For downlink communication, the apparatus may generate a second frame according to the parameters related to the change and may output the second frame for transmission.

As described above, the parameters may relate to switching the mode of operations to one of SISO or SU-MIMO. According to aspects, the parameters may indicate a change in dimension of SU-MIMO operations. The dimension of SU-MIMO may refer to the number of antennas at the transmitter and receiver. By way of example, a 2×2 SU-MIMO configuration refers to two antennae at the transmitter and two antennae at a single receiver that is in communication with the transmitter. As such, the apparatus may generate a second frame according to the SU-MIMO dimension indicated in the first frame and may output the second frame for transmission.

When a wireless node does not have much data to transmit, it may operate in a SISO mode. The SISO mode may effectively be used for transmission of small packets. When the wireless node has more data to transmit, a trigger frame may be used to indicate a request for SU-MIMO operations. When the wireless node has multiple data streams to simultaneously transmit to a receiving device or when the wireless node wants to communicate with multiple receiving devices simultaneously, MU-MIMO may be used.

According to aspects, overall system performance may be improved by an apparatus evaluating the requirements of each wireless node and transmitting individual trigger frames, to each wireless node, based on the evaluation. Further, the apparatus may use the described trigger frames in an effort to efficiently manage air resources. Upon determining a number of usable channels has decreased or increased, the apparatus may trigger a SU mode change or change to MU-MIMO, in an effort to manage available resources. According to one example, the apparatus may determine a number of channels having a channel quality value is equal to or exceeds a threshold value. In response, the apparatus may generate a frame requesting a change to SU operations or a change in the type of SU operations and/or parameters related to the change. For example, in response to determining a number of channels have a channel quality value is equal to or exceeds a threshold value, the apparatus may generate a frame requesting a change from SISO to SU-MIMO or to MU-MIMO.

Switching modes based, at least in part, on a change in number of available and/or usable channels may be driven by many factors and may generally be managed by an apparatus such as an AP. The AP may determine the channel quality value based on measurements, such as signal to noise ratio (SNR) of the channel and/or channel variation. The AP may consider, for example, expected and/or known traffic to and from one or more wireless nodes (e.g., STAs), expected and/or known aggregated AP traffic, and/or service to/from the STA (e.g., video, file downloading, etc.) when determining a number of available channels. According to aspects, the AP may also receive feedback from wireless nodes regarding channel quality.

FIG. 5 illustrates example operations 500, in accordance with certain aspects of the present disclosure. The operations 500 may be performed, for example, by an apparatus (e.g., STA 120, AP 110, or any wireless node). The operations 500 may begin, at 502, by obtaining a first frame comprising one or more fields indicating a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or parameters related to the change. At 504, the apparatus may take one or more actions to communicate in accordance with the change in the mode and/or the parameters related to the change.

As described above, the first frame may be referred to as a trigger frame. For downlink communication, the apparatus may obtain a second frame and process the second frame according to the parameters related to the change. For uplink communication, the apparatus may generate a second frame according to the parameters related to the change and may output the second frame for transmission.

According to aspects, the apparatus may communicate in accordance with the changed mode and parameters related to the change until it receives a subsequent frame comprising one or more fields indicating a subsequent request to change mode for communication and/or parameters related to the subsequent change. According to aspects, the subsequent frame may request a change in mode for communication. Additionally or alternatively, the subsequent frame may indicate parameters related to a change in the mode of operation. As an example, the parameters may indicate a change in dimension for SU-MIMO operation. In this manner, the subsequent frame may include a change in mode for communication, parameters related to the change, or both a change in the mode and parameters related to the change.

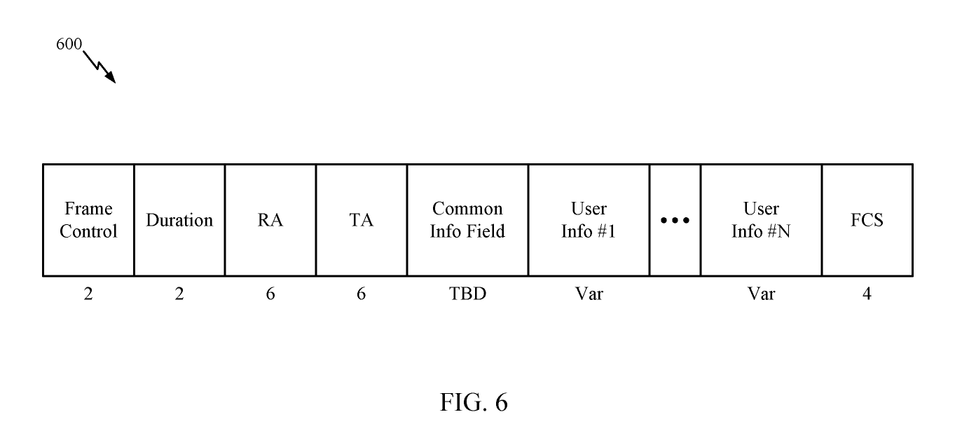

FIG. 6 illustrates an example trigger frame 600, which may be used to indicate a request to change a mode for SU communications and/or parameters related to a change in mode.

After exchanging initial capabilities between stations (e.g., between an apparatus and a wireless node), the transmitter may be able to transmit a request for an SU mode change. As described herein a SU mode change may refer to a switch between one of SISO and SU-MIMO, where SU-MIMO may include SU-MIMO of different dimensions (e.g., 2×2, 3×3, 4×4, etc.). Accordingly, prior to receiving an intended transmission, a receiving station may take one or more actions in an effort to receive the transmission according to the changed mode. According to aspects, both the receiver and the transmitter may already have beamformers trained to the available options. If not, beamformers may be trained prior to the SU mode change.

By using the described method of transmitting an indication requesting a change in mode SU communication and/or parameters related to the change, the transmitter may be able to quickly change SU modes and adapt modulation to the parameters such as channel, traffic and system load. The apparatus transmitting the indication requesting the change in mode of SU communication may keep track of the requested SU mode transmitted to the receiver.

The “Common Info Field” may be followed by one or more “User Info” fields. In SU communication, the illustrated “User Info” fields #1 to #N are for a common user. The combination of the “Common Info Field” and “User Info” fields may be referred to as trigger information fields.

According to an aspect, the “Common Info Field” of the frame 600 may be used to indicate a request to change the SU mode. According to one example, the “Common Info Field” may specify a request to change to a SU-MIMO mode or a request to change to a SISO mode.

A “User Info” field may be used to transmit parameters related to the requested change. The “User Info” field may be addressed to the single SU receiver. For example, the field may include an identification associated with the receiving wireless node, such as an address of the SU receiver, Device ID, etc. Additionally, the “User Info” field may include a SU-MIMO mode switch command code, and the mode to be used in a next frame (e.g., SISO, SU-MIMO 2×2, SU-MIMO 3×3, SU-MIMO 4×4, etc.).

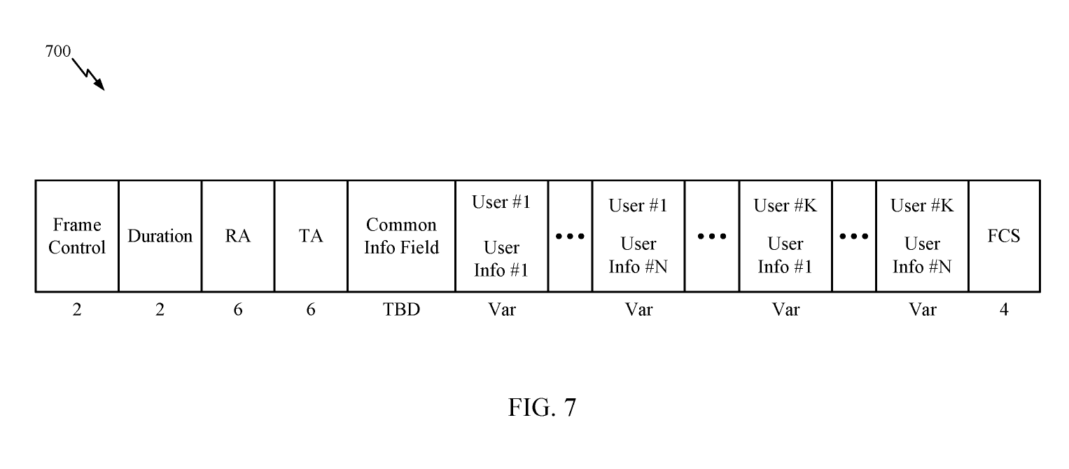

FIG. 7 illustrates an example trigger frame 700, which may be used to indicate a request to change a mode for communications and/or parameters related to a change in mode, according to aspects of the present disclosure.

In FIG. 7, the “Common Info Field” may be followed by one or more “User Info” fields. The “Common Info Field” of the frame 700 may indicate a request to change a mode of communication, wherein the change in mode includes switching to one of SISO, SU-MIMO, or MU-MIMO. The “User Info” fields may be used to transmit parameters related to the requested change. Because trigger frame 700 may be used to indicate a change in mode to MU-MIMO, the “User Info” fields may indicate a user and user information for the specified user. As illustrated in FIG. 7, the frame 700 may include fields for User #1 to User #K and user information (information #1 to #N) for each of the K users. The “Common Information Field” may indicate the value of K and N. The combination of the “Common Info Field” and “User Info” fields may be referred to as trigger information fields.

As described above, an apparatus may transmit a request to change a mode of communication to a wireless node. According to aspects, the wireless node may transmit a request to the apparatus (e.g., STA may transmit a request to the AP). For example, the wireless node may determine an amount of remaining power at the wireless node is less than or equal to a threshold value. In response, the wireless node may transmit, to the apparatus, a request to change the mode. The apparatus may be configured to receive the request and generate a frame indicating at least one of a request to change a mode for communication and/or parameters related to the change, based on the received request.

As described herein a frame, which may be referred to as a trigger frame, may signal change in a mode of communication between a transmitter and a receiver. The mode may be change between SISO, SU-MIMO, where SU-MIMO may include SU-MIMO of different dimensions, and MIMO. The change in mode may be applicable to uplink, downlink, or both uplink and downlink communication. Further, the transmitter and receiver may communicate in accordance with the changed mode until a subsequent trigger frame is transmitted.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 400 and 500 illustrated in FIGS. 4 and 5, respectively, correspond to means 400A and 500A illustrated in FIGS. 4A and 5A.

For example, means for generating a frame comprising one or more fields indicating at least one of a request to change a mode for communication between the apparatus and a wireless node or one or more parameters related to the change in the mode may be performed by the processor 304 in conjunction with the memory 306 of a wireless device 302 as illustrated in FIG. 3. The wireless device may include an AP or STA. According to an example, the means for generating the frame may be performed by one or more of the controller 280 and memory 282 of the user terminal 120 illustrated in FIG. 2 or the controller 230 and memory 232 of the access point 110 illustrated in FIG. 2.

The means for processing a frame may be performed by the processor 304 and memory 306 of the wireless device 302 as illustrated in FIG. 3. According to an example, the means for processing the obtained frame may be performed by one or more of the RX data processor 242, controller 230, or memory 232 of the AP or one or more of the RX data processor 270, controller 280, or memory 282 of the UT illustrated in FIG. 2.

The means for generating a frame according to the parameters related to the change may be performed by the processor 304 in conjunction with the memory 306 of a wireless device 302 as illustrated in FIG. 3. The wireless device may include an AP or STA. According to an example, the means for generating the frame may be performed by one or more of the controller 280 and memory 282 of the user terminal 120 illustrated in FIG. 2 or the controller 230 and memory 232 of the access point 110 illustrated in FIG. 2.

The means for communicating may be performed by one or more of the processor 304, memory 306, transceiver 314, and antenna 316 of the mobile device 302. According to an example, the means communicating may be performed by the controller 280, memory 282, transceiver 254, and antenna 252 of the user terminal 120 illustrated in FIG. 2 or the controller 230, memory 232, transceiver 222, and antenna 224 of the access point 110 illustrated in FIG. 2.

The means for determining a number of channels having a channel quality value that is equal to or exceeds a threshold value may be performed by the processor 304 in conjunction with the memory 306 of a wireless device 302 as illustrated in FIG. 3. According to an example, the means for determining may be performed by one or more of the controller 280 and memory 282 of the user terminal 120 illustrated in FIG. 2 or the controller 230 and memory 232 of the access point 110 illustrated in FIG. 2.

The means for taking one or more actions to communicate may be performed by one or more of the processor 304, memory 306, transceiver 314, and antenna 316 of the mobile device 302. According to an example, the means for taking the one or more actions may be performed by the controller 280 and memory 282 directing the operations of the user terminal 120 illustrated in FIG. 2 or the controller 230 and memory 232 directing the operations of the access point 110 illustrated in FIG. 2.

The means for determining an amount of remaining power at the apparatus is less than or equal to a threshold value may be performed by one or more of the processor 304 and memory 306 of the mobile device 302. According to an example, the means more determining the amount of remaining power may be performed by the controller 280 and memory 282 directing the operations of the user terminal 120 illustrated in FIG. 2 or the controller 230 and memory 232 directing the operations of the access point 110 illustrated in FIG. 2.

The means for generating a request to change the mode may be performed by one or more of the processor 304 and memory 306 of the mobile device 302. According to an example, the means for generating the request may be performed by the controller 280 and memory 282 directing the operations of the user terminal 120 illustrated in FIG. 2 or the controller 230 and memory 232 directing the operations of the access point 110 illustrated in FIG. 2.

The means for receiving and means for obtaining may be performed by the transceiver 314 and antenna 316 of the wireless device 302 illustrated in FIG. 3. According to an example, a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2 may be configured to perform the means for receiving and the means for obtaining.

The means for transmitting and means for outputting for transmission may be performed by the transceiver 314 and antenna 316 of the wireless device 302 illustrated in FIG. 3. According to an example, a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2 may be configured to perform the means for transmitting and the means for outputting for transmission.

According to certain aspects, means may be implemented by processing systems configured to perform the corresponding functions by implementing various algorithms (e.g., in hardware or by executing software instructions) described above for providing changing a mode of operation. For example, the processing system may be configured to perform an algorithm for generate a first frame comprising one or more fields indicating at least one of a request to change a mode for communication between the apparatus and a wireless node, wherein the change in the mode includes switching to one of single-input single-output (SISO), single-user multi-input multi-output (SU-MIMO), or multi-user MIMO (MU-MIMO), or one or more parameters related to the change and a outputting the first frame for transmission. The processing system may be configured to perform an algorithm for obtaining a first frame comprising one or more fields indicating a request to change a mode for communication between the wireless node and an apparatus, wherein the change in the mode includes switching to one of single-input single-output (SISO), single-user multi-input multi-output (SU-MIMO), or multi-user MIMO (MU-MIMO), or parameters related to the change and taking one or more actions to communicate in accordance with the request to change the mode and the parameters related to the change.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a processing system configured to generate a first frame comprising:
one or more fields indicating at least one of a request to change a mode for communication between the apparatus and a wireless node, wherein the change in the mode includes switching to one of single-input single-output (SISO), single-user multi-input multi-output (SU-MIMO), or multi-user MIMO (MU-MIMO) operation, or
one or more parameters related to the change in the mode; and
a first interface configured to output the first frame for transmission.

2. The apparatus of claim 1, wherein the one or more fields of the first frame comprise:
a first field indicating the request to change the mode for communication and a second field indicating the parameters related to the change.

3. The apparatus of claim 1, further comprising:
a second interface configured to obtain a second frame; and
the processing system is further configured to process the second frame according to the parameters related to the change.

4. The apparatus of claim 1, wherein:
the processing system is further configured to generate a second frame according to the parameters related to the change; and
the first interface is further configured to output the second frame for transmission.

5. The apparatus of claim 1, wherein:
the one or more parameters indicate a change in dimension of SU-MIMO operation;
the processing system is further configured to generate a second frame according to the one or more parameters; and
the first interface is further configured to output the second frame for transmission.

6. The apparatus of claim 1, wherein the one or more fields indicate an identification associated with the wireless node.

7. The apparatus of claim 1, further comprising:
a second interface configured to obtain, from the wireless node, a request for the change in the mode; and
wherein the processing system is further configured to generate the first frame based, at least in part, on the request.

8. The apparatus of claim 1, wherein the processing system is further configured to:
determine a number of channels having a channel quality value that is equal to or exceeds a threshold value, and
generate the first frame based, at least in part, on the determined number of channels.

9. An apparatus for wireless communications, comprising:
a first interface configured to obtain a first frame comprising:
one or more fields indicating a request to change a mode for communication between the apparatus and a wireless node, wherein the change in the mode includes switching to one of single-input single-output (SISO), single-user multiple input multiple output (SU-MIMO), or multi-user MIMO (MU-MIMO) operation, or
parameters related to the change; and
a processing system configured to take one or more actions to communicate in accordance with the change in the mode or the parameters related to the change.

10. The apparatus of claim 9, wherein:
the first interface is further configured to obtain a second frame; and
the processing system is further configured to process the second frame according to the parameters related to the change.

11. The apparatus of claim 9, wherein:
the processing system is further configured to generate a second frame according to the parameters related to the change; and further comprising:
a second interface configured to output the second frame for transmission to the wireless node.

12. The apparatus of claim 9, wherein taking the one or more actions comprise:
communicating in accordance with at least one of the change in the mode or the parameters until the first interface obtains a subsequent frame comprising one or more fields indicating a subsequent request to change the mode for communication between the wireless node and the apparatus or parameters related to the subsequent change.

13. The apparatus of claim 9,
wherein the processing system is further configured to:
determine an amount of remaining power at the apparatus is less than or equal to a threshold value;
generate a request to change the mode based, at least in part, on the determination;
and further comprising:
a second interface configured to output the request to change the mode for transmission to the wireless node.

14.-42. (canceled)

43. A station for wireless communications, comprising:
a receiver configured to obtain a first frame comprising:
one or more fields indicating a request to change a mode for communication between the station and a wireless node, wherein the change in the mode includes switching to one of single-input single-output (SISO), single-user multiple input multiple output (SU-MIMO), or multi-user MIMO (MU-MIMO) operation, or
parameters related to the change; and
a processing system configured to take one or more actions to communicate in accordance with the change in the mode or the parameters related to the change.
